(19) United States
(12) Patent Application Publication
(10) Pub. No.: US 2017/0150839 A1
(43) Pub. Date: Jun. 1, 2017

(54) Process for Producing Printed Solid Objects

(71) Applicant: Jerry Surber, Madisonville, TX (US)

(72) Inventor: Jerry Surber, Madisonville, TX (US)

(21) Appl. No.: 15/428,360

(22) Filed: Feb. 9, 2017

Related U.S. Application Data
(63) Continuation-in-part of application No. 15/272,351, filed on Sep. 21, 2016.
Application No. 15/272,351 is a continuation-in-part of application No. 15/015,256, filed on Feb. 4, 2016.
(60) Provisional application No. 62/213,023, filed on Sep. 1, 2015.
(60) Provisional application No. 62/213,023, filed on Sep. 1, 2015.

(51) Int. Cl. A47G 33/00; B44C 5/04; B05D 1/00; B05D 1/28; B05D 1/36

(52) U.S. Cl. CPC A47G 33/004; B05D 1/286; B05D 1/36; B05D 1/60; B44C 5/0469

(57) ABSTRACT

A process for printing the surface of objects such as trophies and plaques including the steps of a) providing a sheet(s) or block(s) of desired shape having surface(s) and edges; b) laminating at least one surface of the objects with heat transfer foil to provide a clear, white or shade of white polymer coating; and optionally, c) printing a design onto the shade of white coating on the surface of the object by UV printing or sublimation printing. Trophies and plaques made by the process. It is also the objects so laminated and/or printed.

### CROSS REFERENCE TO RELATED APPLICATIONS

This application is a continuation-in-part of U.S. patent application Ser. No. 15/015,256 filed Feb. 4, 2016 which claims benefit of Provisional Patent Application Ser. No. 62/213,023 filed Sep. 1, 2015 and a continuation-in-part of 15/272,351 filed Sep. 21, 2016 which application claims benefit of Provisional Patent Application Ser. No. 62/213,023 filed Sep. 1, 2015, the contents and disclosure of each is incorporated herein by reference in their entirety for all purposes.

### BACKGROUND

Field of the Invention

The invention pertains to the printing of solid objects such as plaques, panels and trophies.

Background

Printing on solid substrates is an important industry that is constantly improving in quality and efficiency. The surface of the substrates may be constructed of almost any solid material including: wood, polymer, composites, metal, glass, and the like. Printing of signage, panels, placards, solid banners, billboards, plaques, trophies, and other achievement awards form an important subset of the industry. This conventional process results in expensive trophies and plaques that lack the aesthetic appearance of those having been printed directly onto the trophy or plaque surface and are not easily customizable. Most hand-painted trophies made in China are typically constructed of a polymer resin material in a cold-casting process, which also fails to produce the same quality look and feel of wooden ones.

UV printing machines is another feasible and relatively inexpensive option for printing graphics onto trophies and plaques; however, because of the expense of these machines ($20,000-$30,000), production is typically limited to large suppliers or manufacturers. Being able to customize a print job would be more expedient and efficient for a supplier, such as a dealer or distributor, and could be accomplished through a dye sublimation printing process. (These machines are available for about $5,000.) This invention provides a process to prepare objects for dye sublimation printing.

What is needed is an inexpensive, easily customizable means to provide quality solid objects with graphics and information directly printed on their surface. The present invention provides such means.

### BRIEF SUMMARY OF THE INVENTION

The invention is, therefore, a process for printing the surface of solid objects by laminating at least one surface of a solid object with heat transfer film having a clear, white, or white shade polymer transfer layer to provide a white, white shade, or clear coating on the surface of the object that is ready and suitable for UV printing or sublimation printing.

The invention is also objects laminated by the process to be print-ready and optionally made and printed by the process.

### DESCRIPTION OF THE DRAWINGS

FIG. 1 is a flow diagram of the process, an embodiment of the invention.

FIGS. 2 A, B, and C are pictures of trophies made by an embodiment of the invention.

FIG. 3 are pictures of large plaques made by an embodiment of the invention.

FIG. 4 is a picture of a stacked trophy with wooded risers.

### DETAILED DESCRIPTION

In broad aspect, the invention is a process for improved UV or sublimation printing on solid objects by preparing the surface of the object to be printed with a clear, white, or white shade polymer coating applied with heat transfer polymer film (or foil). The invention is also the object so prepared and optionally printed. In one embodiment, the clear, white, or white shade coating is a polyester polymer. Polyester, polymer-coated substrates are especially suitable for sublimation printing that enables prepared objects to be customized by smaller local dealers or distributors. Examples of the invention process are illustrated in the printing of wooden plaques and trophies and are equally applicable to other solid objects that are to be printed.

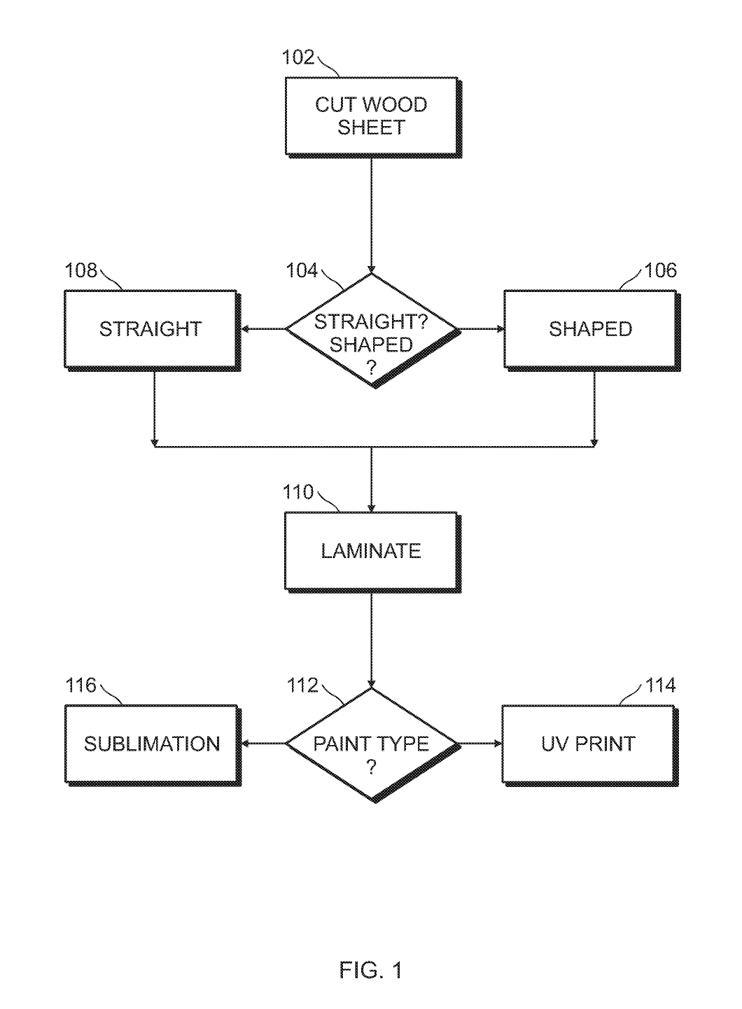

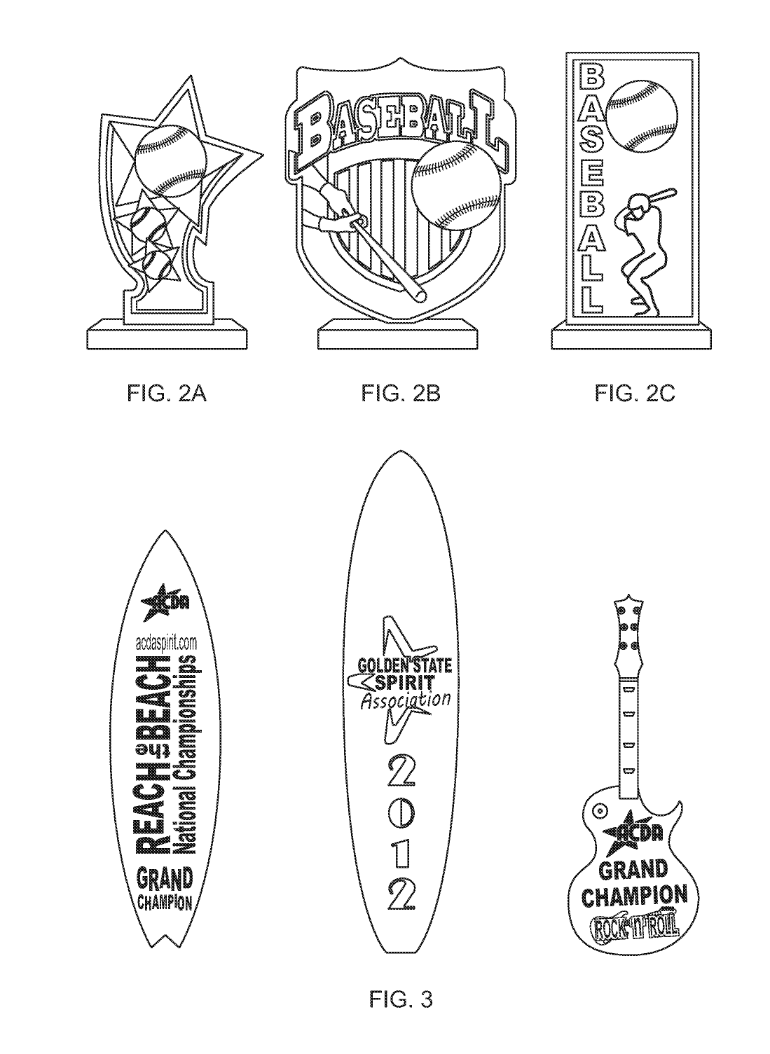

Referring to FIG. 1, flat, medium density fiberboard (MDF) sheet stock is cut into pieces (102). While many hardwoods (and other materials) are suitable for use in the process of the invention, MDF is a customary material for some trophies and plaques and is preferred over other wooden forms. MDF is especially suitable as it is relatively inexpensive, dimensionally stable, and has a very consistent surface for printing. See article at: en.wikipedia.org/wiki/Medium-density fibreboard. Plaques and flat trophies are generally made from ½-inch to one-inch thick sheet, with ⅜-inch thickness being most common. Blocks of MDF (or other solid materials) can also be used to make three-dimensional (block) trophies by the same process. After cutting the sheet(s) (or block) to the desired shape, it is determined (104) if the finished piece is to be straight-edged (as illustrated in FIG. 2C) or shaped (as illustrated in FIGS. 2A and 2B). If shaped, the edges are painted (108), and if straight, the edges can be laminated (106) in the same manner as the surface is laminated (110). Painting the edges requires the following process: paint, sand, repaint, sand, and repaint until a suitably smooth finish is achieved. This is much more time-consuming and expensive than laminating with heat transfer foil (film), which will provide a smooth finish suitable for printing in a single step and at less cost. For painting, it is preferable to use an oil-based lacquer such as Black Lacquer Sealer available from Gemini Coating, Inc. (information available at www.gemini-coatings.com). Black is the preferred and customary color used on edges of plaques and trophies, but any color is within the scope of the process of the invention. Block trophies may have at least one printed side surface (on white coating), and the other side in any other color or pattern.

Shaped pieces are suitably made to desired shape using a computer-navigated control router (CNC). Such routers are well known and are widely commercially available.

The surface (substrate) of the object (optionally with the edges finished) are then laminated with heat transfer film (110) to leave a clear, white, or shade of white polymer coating on the surface.

Suitable laminating machines are commercially available. These machines are hot-roll laminators that bond pre-glued papers and transfer foils as well as other heat sensitive materials onto substrates such as particleboard, MDF, polymer, metal, and other sheet stock. Rollers or a rubber conveyor belt carries the substrate into the machine and under the nip of each roller where heat and pressure securely bond the polymer coating to the substrate. Machines with silicone rollers are preferred for the process of this invention. Machines sold by Fletcher Machine Industries, Inc. of Lexington, N.C. are used successfully.

In general, heat transfer film (sometime called foil) consists of a carrying film, a coating film (sometimes called ink) that is to be transferred to another substrate by heat and pressure and a heat-activated adhesive layer. When the film is placed on a substrate and heat and pressure is applied, the coating is transferred from the film to the substrate and held in place by the adhesive. The carrying film is discarded.

Heat transfer film that is suitable for the process of this invention has a polymer coating (layer, coating, or ink) printed on a polymer carrying film and is coated with an adhesive layer. Polymers that can be made into carrying film typically include PVC (vinyl) PET, Polyurethane, and polyesters. Other polymers that can be made into film and coated are also suitable. The white, white shade, or clear coating layers useful for this invention are those that, when heat is transferred to the object substrate, form the base on which designs and lettering and the like can be printed by UV or sublimation printing. Polymer coating compositions (inks), typically used for coating wood grain and marble patterns, are suitable for use on substrates that are to be printed by UV printing. Polyester coating is especially suitable and is required for sublimation printing per the process of this invention.

An especially suitable film was custom-made to accept dye sublimation inks for a demonstration of the process of this invention. The film (foil) is a clear polymer on which is printed a polyester clear coat, then a white coat, and finally a coat of adhesive, so that when used to laminate onto a substrate, there will be a clear polyester coat on top of a white coat on the substrate of the object to better accept dye sublimation ink. In custom heat transfer film, the polyester clear coat and white coat are mixed.

As discussed above, applying a polymer clear or white coating by laminating with heat transfer film (foil), provides a better surface finish than painting with water or oil-based paints and is much more cost effective. The coating is applied to the substrate surface by a laminating machine that applies heat (typically about 300° F.) and elastomer (usually silicone) rollers. In the process of the invention, the coating that is transferred to the surface of the object is white or near white (a shade of white). This differs from the customary industry coating that uses laminating coating to apply background patterns to the surface of the piece (patterns such as: a wood grain look, a marble look, or the like). The use of a white, a shade of white, or a clear coating, while unknown in the industry, provides a much better base on which to print a suitable customer-specific graphic in the next step (114 or 116) of the process. “Shades of white” are colors that differ only slightly from pure white. Variations of white include what are commonly termed off-white colors, which may be considered part of a neutral color scheme. Colors often considered “shades of white” include, cream, eggshell, ivory, Navajo white, and vanilla. Even the lighting of a room, however, can cause a pure white to be perceived as off-white.” See: en.wikipedia.org/wiki/Shades_of_white. Clear coating means transparent or “sufficiently” opaque and allow shapes to be easily discernable through the film in ambient light. A patterned or colored base coating as is commonly used, would not be suitable for printing per the process of the invention.

As used herein, substrate is defined as the surface of the object to be printed. An applicable dictionary definition is: “the material on which a process is conducted.”

With the surface coated white or near white, the piece is then printed by UV printing (114) or sublimation printing (116). Blocks of wood or other materials used to make three-dimensional block trophies are made in the same manner, and the surface of the edges can also be printed. With UV printing, slightly three-dimensional (textured or sculptured) of up to about 4-mm differentiation (top of surface to bottom of pattern) can be printed. An advantage of this process is that it enables the production of much larger plaques and trophies than the conventional means. FIG. 3 illustrates larger plaques made by the process. The “skateboard” plaque as shown is about 42-inches high, and the guitar plaque about 36-inches. This process provides a unique, much brighter and better defined print that can be easily adapted to small runs of pieces and therefore customizable to the individual customer. Thus, the process of the invention provides a better, more flexible, and more cost-effective means for the manufacture of printed wood plaques and trophies.

The coating is applied to the substrate surface by a laminating machine that applies heat (typically about 300° F.) and elastomer (usually silicone) rollers. Gloss finish coating is preferred, as matt finishes have been found to yellow with age. Thus, matt finishes made from heat-transfer paper are inferior to those produced by a heat-transfer polyester gloss coat. As discussed above, there is a need for prepared objects such as trophies and plaques that are ready for sublimation printing. They allow the object to be prepared on a large scale, which is needed as the equipment is expensive, but customized on site in small and individual batches by dealers and local distributors. As explained above, coating for acceptable sublimation printing should be polyester polymer clear, white, or while shade coatings.

As used herein, “trophies” refers to structures used for recognition, participation, or achievement in an event, as well as sculptures for and including tangible structures having at least one relatively flat surface suitable for printing. “Plaques” as used herein refers to relatively flat solid structures that are fairly thin (about ¼ to 2-inch thickness), that have at least one surface that can be printed, and include award plaques, placards, signboards, decorative wall decorations, and the like. “Plaques” also include signs, decorative banners, placards and billboards. “Laminating” means application of a heat transfer film to a solid object surface by application of heat and pressure in a laminating machine.

“Flatbed UV Digital printing” (“UV” printed as used herein is the reproduction of digital images using inkjet printing, typically on plastic or paperboard, although a wide variety of materials can be printed (common, photographic paper, film, cloth, plastic, etc.). Flatbed digital printers use inks made of acrylic monomers that are then exposed to strong UV-light to cure, or polymerize them. Environmentally, flatbed UV digital printing is based on a more sustainable system than its commercial predecessor of solvent printing, as it produces fewer waste cartridges and less indoor air pollution.” See article: en.wikipedia.org/wiki/Flatbed_digital_printer. Flatbed UV printing allows computer-generated designs to be printed thus making small number and customized trophies or plaques very economical. Flatbed UV printers are relatively expensive and not generally practical for use by small dealers and distributors.

Sublimation printing or “dye-sublimation printing” is a digital printing technology using full color artwork that works with polyester and polymer-coated substrates. The end result of the sublimation process is a nearly permanent, high resolution, full color print. Because the dyes are infused into the substrate at the molecular level, rather than applied at a topical level (such as with screen printing and direct-to-garment printing), the prints will not crack, fade, or peel from the substrate under normal conditions.” See article: en.wikipedia.org/wiki/Dye-sublimation_printer. Sublimation printing equipment is relatively inexpensive and can thus be used by many local dealers and distributors.

In other embodiments, the invention includes solid objects such as trophies and plaques printed by the processes as described above. Objects may be printed on one or more side substrate surfaces and may have a design printed on one surface and a laminated coating of any color or pattern on other side substrate surface. Prototype trophies made by the process of the invention are illustrated in FIGS. 2A, B, and C. All three were made from ⅜-inch MDF, cut to shape, and laminated to provide a white surface coating. The designs as shown were then printed on the white coated surface by UV printing. The trophies may be mounted on suitable bases that allow them to stand upright.

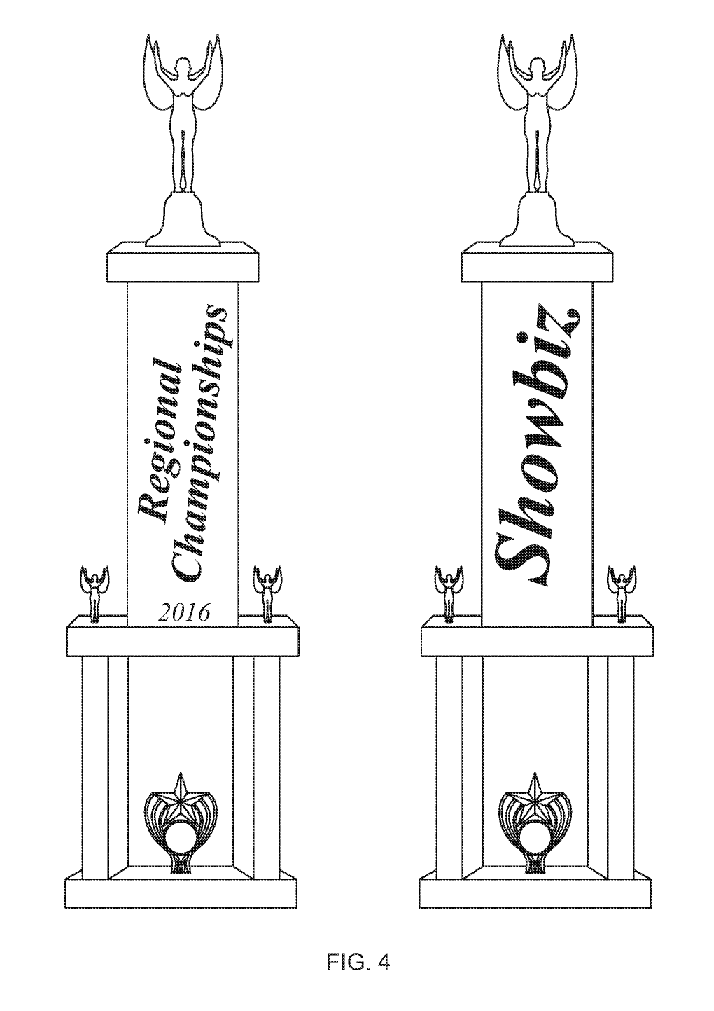

Trophies and other objects may be shaped in any manner as long as there is one surface that is printable per the process of the invention. For example, trophies may have a shaped top section, shaped sides and/or back. In general, block trophies will have a greater ratio of side width to front (or rear) width than plaques. To illustrate, a block trophy will usually have a front surface of at least 2-inch width and a side of at least about 1-inch. For blocks with wider front surfaces, the side will typically be at least about one quarter (¼) the width of the front. Block trophies may have a base (wood or marble is preferred), a lid (wood or marble is preferred), and may also have a figurine or a riser and figurine attached to the top. FIG. 4 illustrates trophies with a marble base, two wooden risers, a lid, and an additional larger printed riser with a marble lid and a figurine on top. The riser(s) are printed according to the process of the invention.

In the foregoing specification, the invention has been described with reference to specific embodiments thereof. It will, however, be evident that various modifications and changes can be made thereto without departing from the broader spirit and scope of the invention as set forth in the appended claims. The specifications and drawings are, accordingly, to be regarded in an illustrative rather than a restrictive sense. Therefore, the scope of the invention should be limited only by the appended claims.

1. A process for printing the surface of solid objects comprising:
a) providing an object of a desired shape having a surface(s) and edges;
b) laminating at least one surface of the object with heat transfer film to provide a clear, white or shade of white polymer coating;
c) printing a design onto the coating on the surface of the piece by UV printing or sublimation printing.

2. The process of claim 1 wherein some edges of the objects are painted.

3. The process of claim 1 wherein the polymer coating is a polyester polymer.

4. The process of claim 1 wherein the object(s) are trophies, plaques, signs, panels, billboards and banners.

5. The process of claim 1 wherein the surface of the object to be printed has a sculptured design pattern with depth differentiation of the sculptured surface of no more than 4 mm.

6. The process of claim 1 wherein the wherein the solid object to be painted is a wooden sheet sized from about ½ to 1 inch thickness and the edges of the cut pieces are laminated with a heat transfer foil coating or painted.

7. A produced by:
a) providing a trophy or plaque of a desired shape having a surface(s) and edges;
b) laminating at least one surface of the trophy or plaque with heat transfer film to provide a clear, white or shade of white polymer coating;
c) printing a design onto the coating on the surface of the piece by UV printing or sublimation printing.

8. The trophy or plaques of claim 7 wherein the polymer coating is a polyester polymer.

9. The trophy or plaques of claim 7 wherein the trophy or plaque is wooden.

10. The trophy or plaques of claim 7 wherein the surface of the piece to be printed is sculptured in a design pattern with depth differentiation of the sculpture of no more than 4 mm.

11. A process for preparing the surface of solid objects for supplementation printing comprising:
a) providing solid object(s) having surface(s) and edges; and
b) laminating at least one surface of the object with heat transfer film to provide a shade of white coating.

12. The process of claim 11 wherein the polymer coating is a polyester polymer.

13. The process of claim 11 wherein the edges of the object are painted.

14. The process of claim 11 wherein the coated object(s) of b) are printed by UV or sublimation printing.

15. The process of claim 11 wherein the object(s) are trophies, plaques, signs, panels, billboards and banners.

16. The process of claim 11 wherein the object(s) are made of wood.

17. The process of claim 11 wherein the heat transfer film comprises is a clear polymer film on which is printed a polyester clear coat, then a white coat, and finally a coat of adhesive, so that when used to laminate onto a substrate, there will be a clear polyester coat on top of a white coat on the substrate of the object to better accept dye sublimation ink.

18. The process of claim 17 wherein the polyester clear coat and white coat are mixed.
